(19) United States
(12) Patent Application Publication
(10) Pub. No.: US 2007/0187177 A1
(43) Pub. Date: Aug. 16, 2007

(54) Step assembly

(76) Inventor: Dale Jonathan Hemming-Tayler, Meysey Hampton (GB)

Correspondence Address: KING & SCHICKLI, PLLC, 247 NORTH BROADWAY, LEXINGTON, KY, 40507, US

(21) Appl. No.: 10/592,099

(22) PCT Filed: Mar. 11, 2005
(86) PCT No.: PCT/GB05/00945

§ 371 Date: Sep. 7, 2006

(30) Foreign Application Priority Data
Mar. 18, 2004 (GB) 0406053.9

(51) Int. Cl. E06C 1/00

(52) U.S. Cl. 182/35

(57) ABSTRACT

This invention relates to step assemblies and in particular, but not exclusively, to step assemblies for use in conjunction with fitted furniture such as is frequently found in the kitchen, dining room or garage or indeed shops. The assembly includes an open-mouthed chassis or carcass (15) and a body, generally indicated at (21), which comprises two dock portions (22) and (23), which are hinged at (24) so that they can take up either a flat storage configuration or a step forming configuration. For storage the body can be slid within the chassis, which sits beneath, for example, a kitchen unit, when the body is in its flat configuration.

### Step Assembly

This invention relates to step assemblies and in particular, but not exclusively, to step assemblies, for use in conjunction with fitted furniture such as is frequently found in the kitchen, dining room or garage or indeed in shops.

As the pressure for increased housing gets greater, the tendency is to build units with smaller rooms and this means, that in order to maintain sufficient levels of storage space, the wall hung units often extend up to at least close to the ceiling, with the result that the higher shelves are out of reach of much of the population, when they are stood on the kitchen floor. There are a number of low level folding steps that are available on the market, which can enable such users to reach the higher shelves, but these, themselves, can introduce storage problems.

From one aspect the present invention consists in a step assembly including a body having at least two articulated portions and a chassis for slidingly receiving the body, the portions of the body being dimensioned and connected for movement between a first, in line position in which they can be received in the chassis and a second, step forming, position in which the body at least partly projects from the chassis and one portion can rest on the other to form a step.

It will be appreciated that the chassis can be positioned beneath the carcass of a fitted unit so that the body is entirely stored away when not in use and it can then be pulled out to form a step, when access to high level storage is required.

Preferably the portions interconnected such that the free end of the one portion is directed towards the chassis when it rests on the other. For most purposes a single level of raised platform will suffice, but it will be appreciated that if there are more than two portions, further elevated positions can be achieved. The additional portion may not be articulated but may, for example, be a block stored in the one portion and placeable thereon if required.

The abutted ends of the portions are preferably hinged together. The portions may be generally in the form of blocks.

The body and the chassis may have interconnecting formations for defining the sliding movement. Most conveniently these are in the form of traditional drawer runners fitting within longitudinal slots in the body, but other runner arrangements could be utilised. Preferably the assembly includes at least one stop or stop device for preventing complete withdrawal of the body from the chassis.

The free end of one portion may include an opening or formation for facilitating withdrawal of the body from the chassis and/or movement from the first position to the second position. It may for example have a half moon opening, in which a user's toe can be inserted initially to withdraw the body from the chassis and then to flip the one portion up onto the other portion. Such a formation may also be used to return the body to its in-line position.

Additionally or alternatively one or both sides of the one portion may include one or more formations for facilitating movement from the second position to the first. For example, there maybe a notch, into which the welt of a shoe can be inserted to flick the step back.

In that case, in particular, the surface of the one portion which is uppermost in the second position may be formed of a rubber or other shock absorbing material. This also has the advantage, most commonly, of providing an anti-slip surface. There may however be a compromise required, in that case, because the overall friction between the body and the floor, does not need to be inconveniently high when the body is being inserted or withdrawn from the chassis.

The chassis may be in the form of an open mouthed carcass. Whatever form it takes it may include a mounting plate for mounting the chassis to the rear of a plinth or kick board.

The chassis and/or the body are formed from plastic mouldings. The chassis and/or body may have further interengaging formations for releasably defining at least one relative position of the body and chassis.

The invention also includes a furniture unit including a unit carcass and legs for supporting the carcass above floor level and a step assembly as defined above having its chassis located beneath the unit carcass.

The unit may further included a kick board or plinth attached to the legs, in which case the chassis may be attached to the kick board or plinth.

Although the invention has been defined above it is to be understood that it includes any inventive combination of the features set out above or in the following description.

The invention may be performed in various ways and a specific embodiment will now be described, by way of example, with reference to the accompanying drawings, in which;

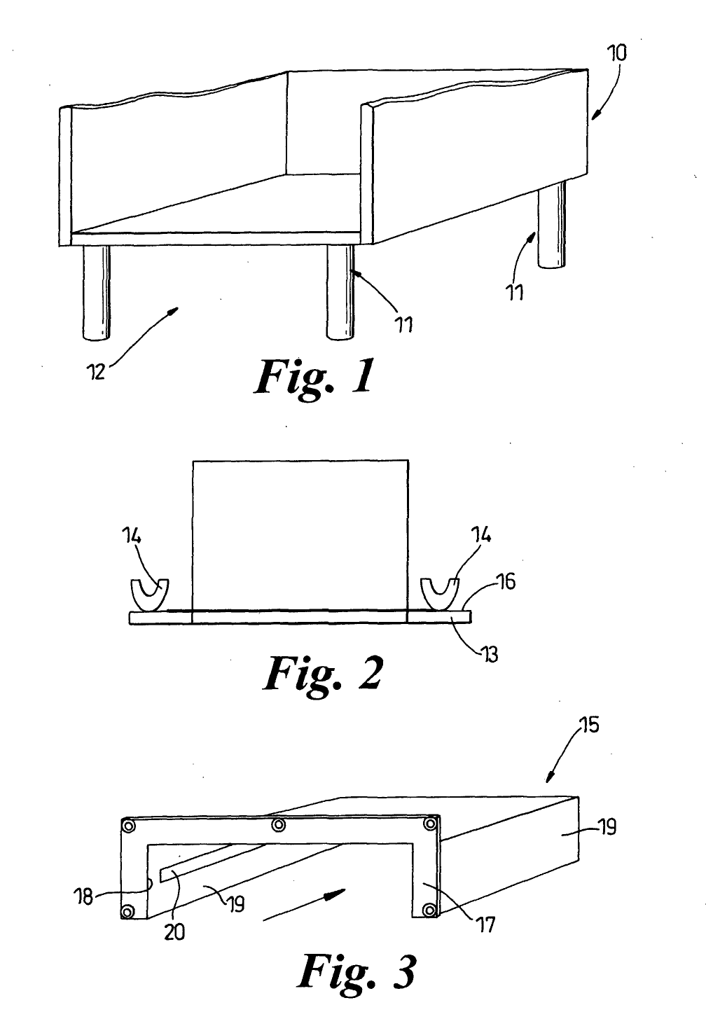

FIG. 1 is a perspective view of the bottom portion of a furniture carcass supported on legs;

FIG. 2 is a view from above of a plinth associated with the unit of FIG. 1 with a chassis mounted thereon;

FIG. 3 is a perspective view of the chassis of FIG. 2;

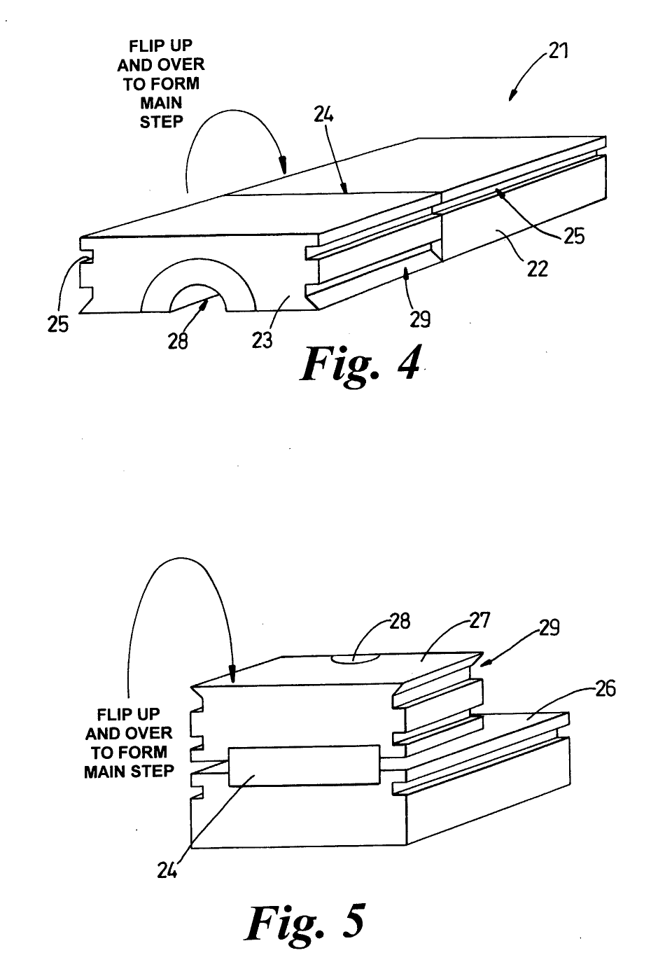

FIG. 4 is a perspective view of a step forming body in its storage configuration;

FIG. 5 is a view of the body of FIG. 4 in its step forming configuration;

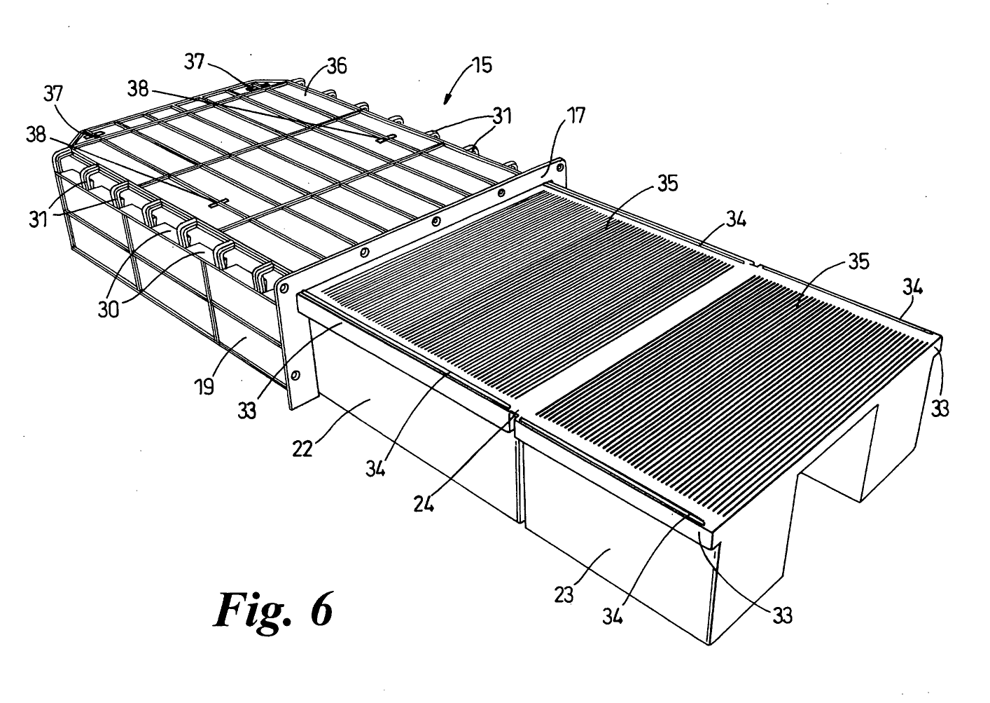

FIG. 6 is a view to one side and from above of a moulded plastics embodiment of a step currently in an extended position;

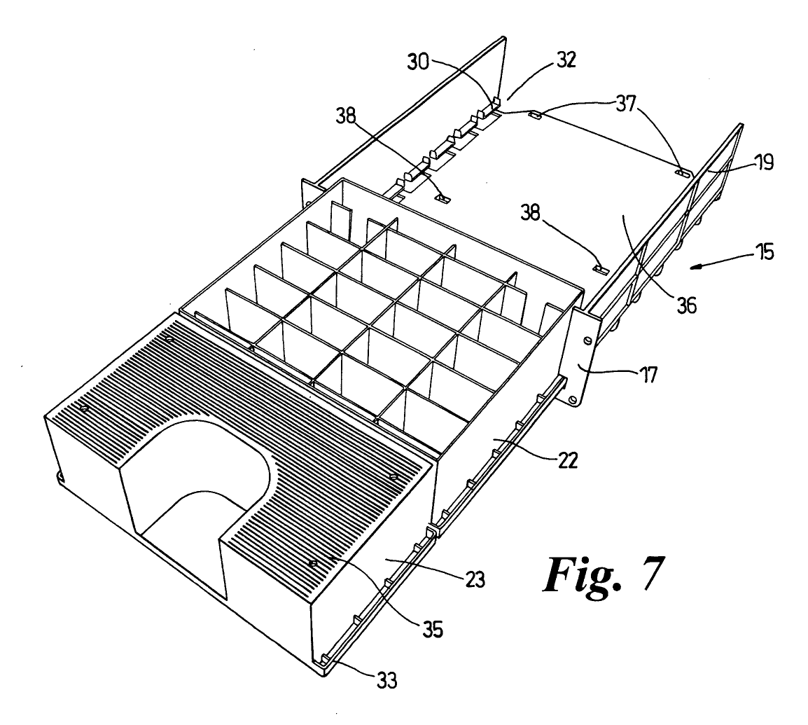

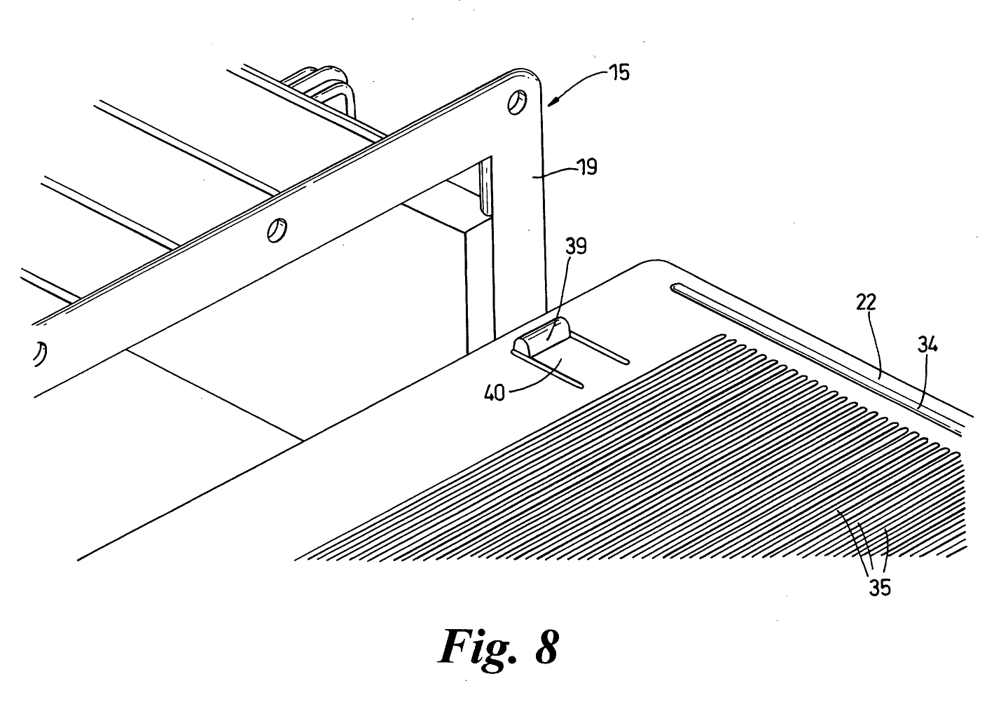

FIG. 7 is a view to the other side and below of the assembly of FIG. 6; and

FIG. 8 is an enlarge view of a portion of a disassembled step assembly of FIG. 6.

FIG. 1 illustrates a furniture unit carcass, generally indicated at 10, having legs 11 which support the carcass 10 above a floor to define a space, which is generally indicated at 12.

Conventionally the front pair of legs 11 carry a plinth 13 by means of clips 14 to close off the space 12.

In the Applicant's proposal a box like open-mouthed chassis or carcass 15 is attached to the rear face 16 of the plinth 13 by means of a mounting plate 17 and the plinth 13 is cut away to form an opening corresponding with the mouth 18 of the chassis 15. The side walls 19 of the chassis 15 are formed with longitudinal runners 20.

Turning to FIGS. 4 and 5, a step forming body, generally indicated at 21 comprises two generally block like portions 22 and 23, which are hinged at 24 so that they can take up either a flat, storage, configuration illustrated in FIG. 4 or a step forming configuration as illustrated in FIG. 5. The portions 22, 23 may be solid but are preferably hollow. Portion 22 may be open at its base.

It will be noted that both portions 22, 23 are formed with aligned longitudinal grooves 25 which are located and dimensioned to receive runners 20 on the chassis 15, so that the body 21 can be slid into the chassis 15, as indicated by the arrow in FIG. 3, and can be partially withdrawn from the chassis 19 to a position in which at least part of the portion 22 projects beyond the plinth 13. Preferably a stop arrangement is provided so as to prevent complete withdrawal of the body 21 in normal usage. When withdrawn the body 21 can provide a low level step, but it is preferred that portion 23 is flipped up so that it lies on the upper surface 26 of portion 22, as illustrated in FIG. 5, to form a step or standing surface 27.

It will be noted that the portion 22 is formed with a half moon opening at 28. This is designed so that a user's toe can be inserted to withdraw the body 21 from the chassis 15. The user can then, with their toe, flip the second portion over into the FIG. 5 position.

It will also be noted that further longitudinal grooves 29 are provided in the second portion 22 so that in the FIG. 5 position they provide an overhanging formation. This can be engaged by the welt of the user's shoe to flip the step back into the horizontal in-line position of FIG. 4 before the body 21 is pushed back into the chassis 15 after use.

The drawings show a single unit width step assembly, but it will be appreciated that a double width assembly could be contained under a double width unit.

The invention therefore provides a step assembly which can be readily stored under existing kitchen units and withdrawn to provide a standard surface of step for the user wanting to access high level storage. When use is complete the step can then be moved out of the way. The product can be conveniently retrofitted, but particularly when it comes as original equipment, the free end of portion 23 can be coloured so as to match the front face of the plinth 13 so as to enhance the visual appearance.

Although an ordinary hinge is illustrated at 24, it will be understood that any suitable articulate connection can be used. For example cranked side bars may provide the up and over lift required or a parallel bar hinge such as used in some sewing boxes, could be utilised.

FIGS. 6 to 8 illustrate a production version of the step assembly. Here the components are moulded in plastics and whilst the operation of the structure is more or less identical to that of the previous embodiments there are one or two changes which have been incorporated. First the combination of runners 20 on the chassis and grooves 25 on the body portions 22, 23 are replaced by shelves 30 and arches 31, which define runner ribs 34 are provided on the upper surface of the bodies 22, 23 to ensure that the runners 34 sit properly in the grooves 32 and run smoothly therein. The working faces of the bodies 22, 23 are also covered with ribs 35, to provide better grip.

To ensure positive location of the bodies 22 and 23 in their various working positions, the roof 36 of the chassis 15 is provided with pairs of aligned recesses, some of which are shown at 37 and 38, which define the fully closed position; the single step position and the fully withdrawn position.

Curved stops 39, one of which is illustrated in FIG. 8, are formed on the trailing part of the body 22 to locate into these recesses, during normal sliding. Each stop is marked on a respective tongue 40 which act as a spring that allow the stop 39 to be deflected downwardly before urging the stop 39 upwardly. Thus with an increased force they can be cammed out of the recesses 37 and 38. The recesses corresponding to the fully withdrawn position are not illustrated.

1. A step assembly including a body having at least two articulated portions and a chassis for slidingly receiving the body, the portions of the body being dimensioned and connected for movement between a first, in line, position in which they can be received in the chassis and a second, step forming, position in which the body at least partially projects from the chassis and one portion can rest on the other to form a step.

2. An assembly as claimed in claim 1 wherein the portions are interconnected such that the free end of the one portion is directed towards the chassis when it rests on the other portion.

3. An assembly as claimed in claim 2 wherein the abutting ends of the portions are hinged together.

4. An assembly as claimed in claim 2 wherein the portions are generally in the form of blocks.

5. An assembly as claimed in claim 1 wherein the body and the chassis have interconnecting formations for defining the sliding movement.

6. An assembly as claimed in claim 1 including at least one stop or stop device for preventing complete withdrawal of the body from the chassis.

7. An assembly as claimed in claim 1 wherein the free end on the one portion includes an opening or formation for facilitating withdrawal of the body from the chassis and/or movement from the first position to the second position.

8. An assembly as claimed in claim 1 wherein one or both of the sides of the one portion includes one or more formations for facilitating movement from the second position to the first position.

9. An assembly as claimed claim 1 wherein the chassis is in the form of an open-mouthed carcass.

10. An assembly as claimed in claim 1 wherein the chassis includes a mounting plate for mounting the chassis to the rear of a plinth or kick board.

11. An assembly as claimed in claim 1 wherein the chassis and/or body are formed from plastics mouldings.

12. An assembly as claimed in claim 1 wherein the body and chassis are formed with further interengaging formations for releasably defining at least one relative position of the body and chassis.

13. (canceled)

14. A furniture unit including a unit carcass and legs for supporting the carcass above floor level and a step assembly as claimed in claim 1 having its chassis located beneath the unit carcass.

15. A unit as claimed in claim 12 further including a kick board or plinth attached to the legs wherein the chassis is attached to the kick board or plinth.
